(19) United States
(12) Patent Application Publication
(10) Pub. No.: US 2008/0014653 A1
(43) Pub. Date: Jan. 17, 2008

(54) Spectral analysis system utilizing water vapor plasma

(75) Inventors: Scott Harris Bloom, Encinitas, CA (US); Eric Oscar Hemberg, Encinitas, CA (US); Robert Bible, Rancho Santa Fe, CA (US)

Correspondence Address: John R. Ross, PO Box 2138, Del Mar, CA, 92014, US

(73) Assignee: Elementum labs, Inc.

(21) Appl. No.: 11/827,731

(22) Filed: Jul. 13, 2007

Related U.S. Application Data
(60) Provisional application No. 60/830,469, filed on Jul. 13, 2006.
(60) Provisional application No. 60/830,746, filed on Jul. 14, 2006.

(51) Int. Cl. G01J 3/443; G01J 3/00

(52) U.S. Cl. 436/171; 422/82.05

(57) ABSTRACT

A system and method for analysis of minute quantities of contaminants in water. Liquid water is converted to water vapor and then excited into a plasma state with microwave radiation. Optical emissions from the plasma are spectrally analyzed to provide qualitative and/or quantitative analyses of the contaminants in the water. Preferred embodiments provide special techniques for generating the water vapor from a water stream; exciting the water vapor to a plasma state; varying and controlling the plasma energy; introducing samples into an existing plasma; collecting emissions from the plasma from a variety of angles; selecting the optical collection angles; protecting the analysis optics from the plasma; exhausting the spent plasma gases back into the water stream; and analyzing the results to yield concentrations of elements and molecules in the sample.

### CROSS-REFERENCE TO RELATED APPLICATIONS

This application claims the benefit of Provisional Patent Applications, Ser. No. 60/830,469 filed Jul. 13, 2006 and Ser. No. 60/830,746 filed Jul. 14, 2006.

### FIELD OF THE INVENTION

This invention relates generally to spectral analysis systems and in particular to such systems utilizing microwave or radio frequency driven plasma spectrometers.

### BACKGROUND OF THE INVENTION

The use of plasma sources for elemental excitation and spectral analysis is currently the primary means for sensitive detection of trace elements in solids, liquids and gases. Several of the prior art techniques for excitation and detection are described in U.S. Pat. No. 6,081,329 which is incorporated herein by reference.

The minute quantities of contaminants in samples are detected with inductively coupled plasma spectrometers. Typically, in these instruments, a small sample is introduced into a plasma, which breaks the sample down to its elemental components. These components can subsequently be identified through a variety of techniques. These include optical emissions in which the characteristic emissions lines for each element are resolved and measured to determine existence and quantity. Atoms can also be scavenged from the plasma and introduced to a mass spectrometer for identification.

Typically these types of analyses are performed in laboratories on samples that are collected and transported to the laboratory. The most widely used technology relies on using argon as the plasma gas. This is because: argon forms a stable plasma, has a high activation energy is optically transparent in the ultraviolet spectral range and is readily available. Argon gas is expensive. Other gases such as Helium, Nitrogen and Oxygen have also been used as the plasma gas with limited success.

There is a need for a system to do this type of analysis in online in the field for 24 hour 7 day monitoring without the use of special expensive gasses.

### SUMMARY OF THE INVENTION

The present invention provides a system and method for analysis of minute quantities of contaminants in water. Liquid water is converted to water vapor and then excited into a plasma state with microwave or radio frequency radiation. Optical emissions from the plasma are spectrally analyzed to provide qualitative and/or quantitative analyses of the contaminants in the water. Preferred embodiments provide special techniques for generating the water vapor from a water stream; exciting the water vapor to a plasma state; varying and controlling the plasma energy; introducing samples into an existing plasma; collecting emissions from the plasma from a variety of angles; selecting the optical collection angles; protecting the analysis optics from the plasma; exhausting the spent plasma gases back into the water stream; and analyzing the results to yield concentrations of elements and molecules in the sample.

The ability to monitor drinking water supplies on a continuous basis is one of the benefits of this technology. Monitoring can be used on both the raw feed water and the processed water prior to distribution. The potential low cost of this technology even makes it possible to envision monitoring of water quality through out the distribution system. For water suppliers the ability to continuously monitor the quality of feed water, allows them to use water sources of less stable quality, creating new potential sources. The ability to monitor pre and post filtering enables them to operate the filtering in the most efficient manner. This is especially important with membrane systems such as reverse osmosis where accurate measurements of membrane loading can be used to reduce operating costs. For water emitters, this technology provides a cost effective method of assuring compliance with emission standards. Food and beverage producers and bottlers in areas with questionable water supply quality such as in developing countries can use this technology to assure quality and safety of their finished products. Those with stable supplies of high quality can reduce their operating cost by reducing the regulatory sampling costs. Any water user or emitter who has a high cost associated with contamination either financial, liability or regulatory can benefit from this equipment.

### BRIEF DESCRIPTION OF THE DRAWING

FIG. 1 is a block drawing of a preferred embodiment of the present invention.

FIG. 2a shows an input portion of the preferred embodiment.

FIG. 2b shows an expanded version of the FIG. 2a portion.

FIG. 3 shows an alternate input portion.

FIG. 4 shows a light source portion of a preferred embodiment

FIG. 5 shows some optical features of the preferred embodiment.

FIG. 6 shows features of an output stage.

FIGS. 7, 8 and 9 show techniques for optical protection.

### DESCRIPTION OF THE PREFERRED EMBODIMENTS

### First Preferred Embodiment

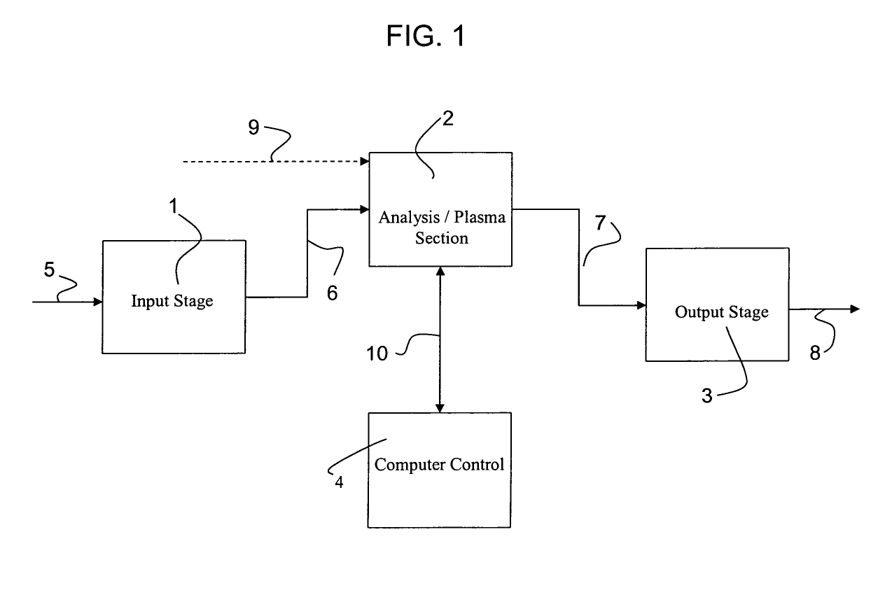

A first preferred embodiment of the present invention can be described by reference to the drawings. FIG. 1 shows an overall block diagram of the first preferred embodiment, separating the system into schematic functional units. These include an input stage 1 that takes input water and converts it to water vapor. It can also be used to concentrate the impurities to increase detection sensitivities, and or create pure water for additional analysis. An analysis/plasma subsection 2 receives control signals from computer control unit 4 programmed with special algorithms, creates a plasma, analyzes a spectral output and transmits results. Spent plasma gas is recombined into mostly water vapor with some other byproducts and the combination is sent to the output stage 3. In output stage 3, the recombined water and any gases 7 are incorporated into an output water stream 8. Additionally, the waste heat is recovered as preheat on the input water 5. Callout 9 shows an optional sample and/or reference introduction port separate from the input water. This may be used if the apparatus's water supply is not the same as the samples of interest or to input reference samples for calibration purposes.

### Input Stage

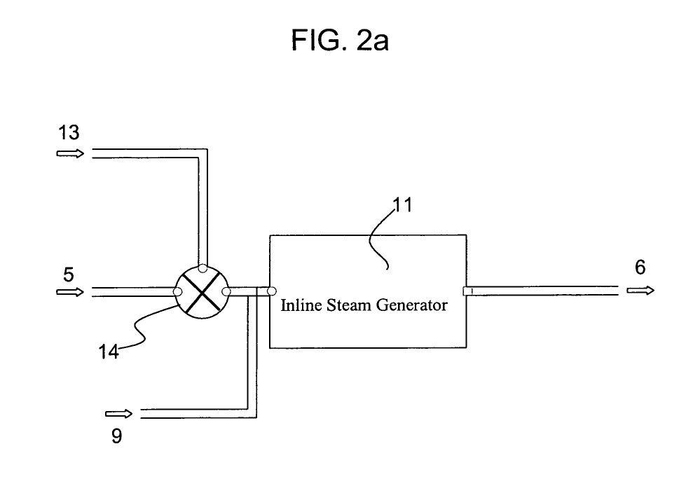

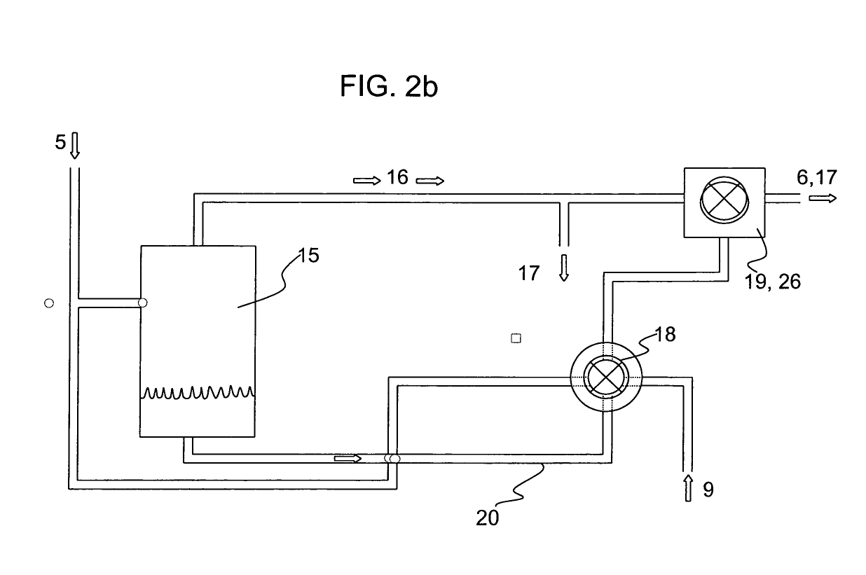

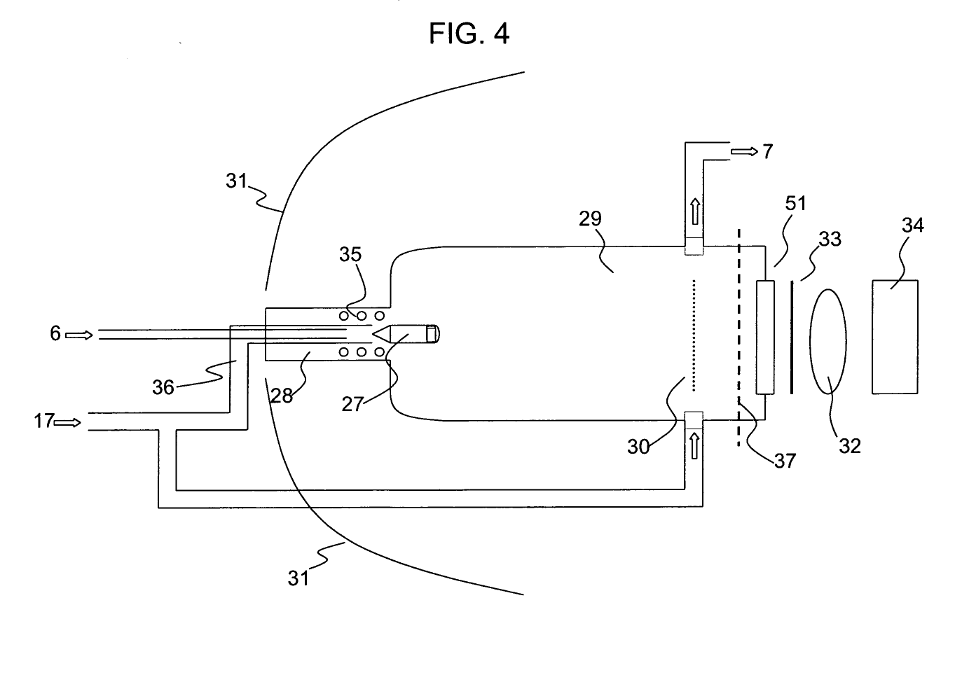

A simple implementation of the input stage is shown in FIG. 2a. Input water 5 which has been preheated by cooling the exhaust elsewhere in the apparatus flows into a steam generator 11 that boils the water as it passes through generating water vapor. The water vapor 6 is sent to the plasma section 2 detailed in FIG. 4. Callout 9 and 13 show optional references or alternate sample input ports which can be selected with a selector valve 14. Input 9 is shown with an implied external valve, but it may actually flow into the selector valve as another input port. An external valve on Callout 9 assumes valve 14 has a closed position.

FIG. 2b shows an addition of a boiler/concentrator 15 and additional valves and plumbing to the simple input stage of FIG. 2a. This is an alternative implementation of the input stage. Input water 5 which has been preheated by cooling exhaust gases elsewhere in the apparatus flows into vessel 15 where the water is boiled generating water vapor and concentrating impurities in vessel 15. The water vapor, 16, contains releases dissolved gases and volatile organic compounds in addition to water vapor which are sent to the plasma section detailed in FIG. 4. The water vapor 17 sent to the analysis section for the plasma gas contains both the water vapor and the released dissolved gases and VOCs. The composition of these contaminants may be derived by switching the sample gas selector valve 26 and looking at the change in spectral outputs. The input stage also contains valves and plumbing to select the sample and provide automatic flush and cleaning. Valve 18 selects sampling from either the concentrated input 20 or the raw input 5 or an external source 9. Atomizer vaporizer 19 combines the resulting sample stream with the water vapor from vessel exhaust 16 vaporizing the sample and passing it on to sample input 6 in the analysis plasma section shown in FIG. 4.

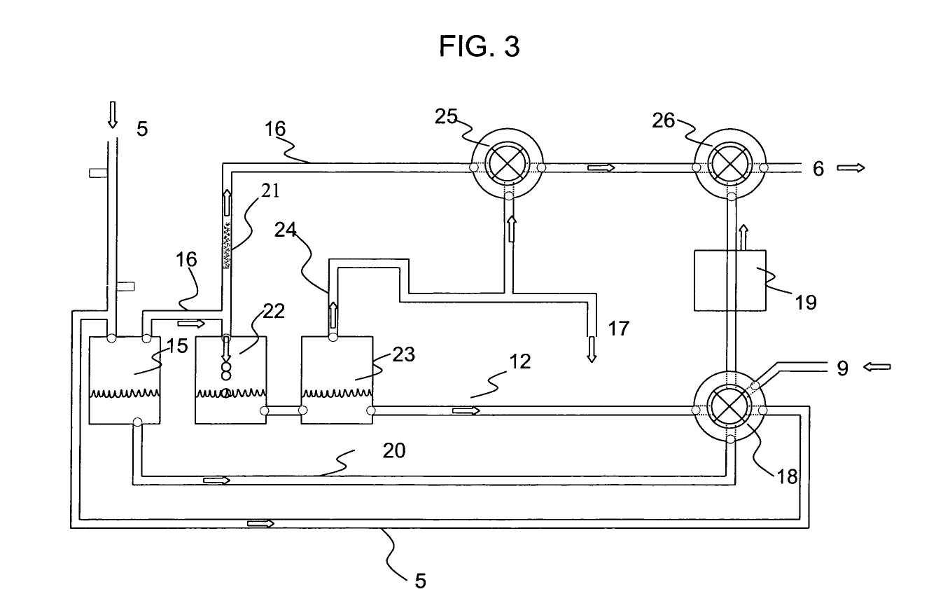

FIG. 3 shows a more complex implementation of the input section. This contains a hot finger distillation stage to allow generation of pure water vapor. The operation of this implementation is as described above with the addition of a hot finger condenser 21 which provides for the generation of pure water in vessel 22 from vapor 16, coming from boiler/concentrator 15. The pure water then subsequently is used in vessel 23, the pure water boiler or inline steam generator 11 to generate pure water vapor 24, for the analysis stage 2, and 17, the water vapor for the main plasma gas. Selector valves 25, and 18 now allow selection of the sample gas 6 that includes: vapor byproducts 16 of the initial distillation, e.g. the volatile organics, released dissolved gasses and other low boiling point contaminants in the raw sample, the concentrated sample #20, from vessel 15, pure water sample 12 from vessel 22 or an external sample 9. The output of theses selector valves is directed to an atomizer/vaporizer 19 which converts the liquid stream to vapor. The final selection of the sample gas 16 is done by a selector valve 26, which can select from the gases from the distillation process or the vapors from the liquid selector valve.

### Plasma/Analysis

Referring to FIG. 4, the analysis/plasma function takes the water vapor 6 and water vapor 17 and sends it through the plasma torch 28. In the plasma torch 28 the water vapor is excited either with microwaves at 2.45 Ghz, or with the inductively coupling of RF energy at 27.12 MHz or 40.68 MHz by the RF coils 35. The excitation creates plasma 27, made of primarily hydrogen and oxygen atoms into which the sample is injected. This happens in a sealed chamber 29 made of fused ultraviolet silica. Additional porting may be provided (not shown) to create a shield gas around the plasma from plasma gas 17.

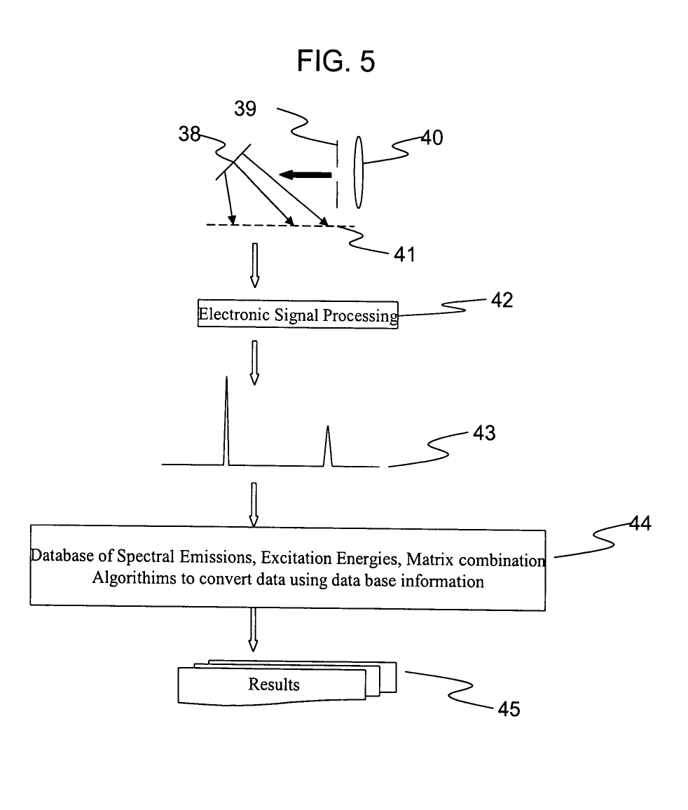

The plasma temperature and density is varied by computer control, through regulation of the excitation power, microwave or RF, and the flow rates. At the temperatures prevailing in the plasma a significant proportion of the atoms of many chemical elements are ionized, each atom losing its most loosely bound electron or electrons to form charged ions (singly or multiple charged). The lost electrons are excited to higher energy states and as they return towards ground states in the atoms, they emit photons of characteristic frequencies. These photons are collected by the elliptical collection mirror 31 and collection optics 32. The angle of collection can be changed from radial to all axial with a variable obscuration aperture 33 by selecting the geometric angles as they map onto aperture 39 (shown in FIG. 5) at a non-focal plane. By using a pupil, varying degrees of telecentrity can be obtained, and similarly an axial obscuration can create radial only collection. The collected photons are then transmitted to the spectrometer 34, as detailed in FIG. 5. The exhaust gases 7 are directed to the output stage 3. Also shown in FIG. 4 is a spark gap 36 which creates initial free electrons to ignite the plasma, and multiple layers of protection for the collection object. These layers of protection include: clean vapor 30 and mechanical protection 37 as described in more detail below.

Microwave energy is preferably created by a standard commercial magnetron such as the MAG2M167BM23 from Panasonic Corporation with offices in Secaucus, N.J.

### Spectrometer

FIG. 5 shows a schematic representation of a preferred spectrometer, represented as subunit 34 in FIG. 4. Photons are input at 40 and pass through transfer optics, which may be conventional lenses or fibers. The photons are directed through an entrance aperture 39 (typically a slit, though other shapes can be used) then directed at grating 38 (which may be a series of gratings) to diffractively separate the light into its fundamental frequencies. The diffracted light falls on sensor array 41 which collects the photons and converts them to electrical signals. The resulting signals are then converted to spectral emissions data 43 which show the frequency distribution and number (intensity) of the input photons. This data is then used by special algorithms 44 that rely on a database of spectral emissions charts and data of interactions for multiple elements to identify the contaminants and the concentrations in the sample, giving results 45 in an element-by-element breakdown of the concentrations in the sample.

Commercially available spectrometers such as the C10082 available from Hamamatsu Corporation, Bridgewater, N.J. or the 78125 UV-VIS Matrix Spectrometer from Newport Corporation, Stratford, Conn. include the basic components as described above and the signal processing necessary to generate spectral output data.

Not shown in FIG. 5 is the extensive use of algorithmic noise reduction via collection of data from the multiple sources and from varying power levels and light angles to augment the information available. These algorithms allow self-calibration on an almost continuous basis. They also allow extension of this instrument beyond the traditional elemental analysis to molecular identification.

### Output Stage

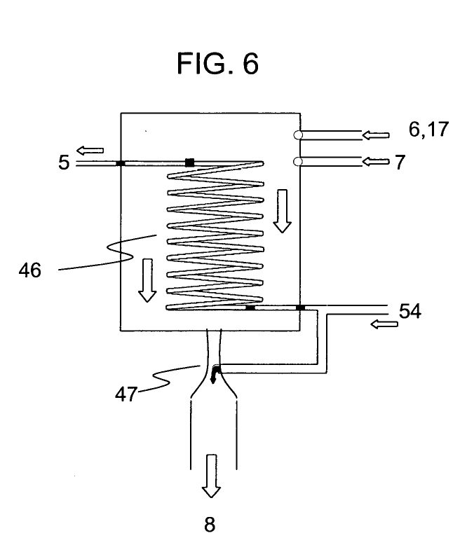

FIG. 6 shows the output stage where the gases and water vapor, 6, 7 and 17 are combined with the supply water to form the outgoing wastewater stream 8 via venturi-aspirator 41. The heat energy in the gases 6 and 7 is extracted with a heat exchanger 46 into the input water 54, which is then passed on as 5 to one of the input sections described above in FIGS. 2a, 2b, and 3.

### Protection of Optics

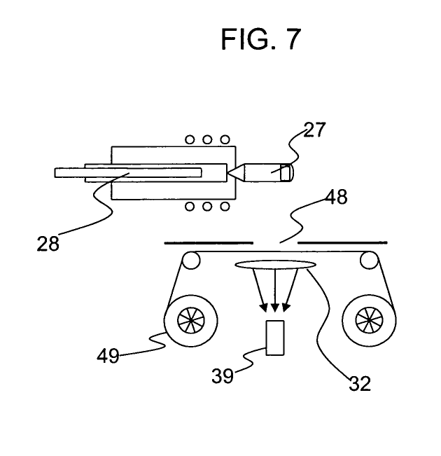

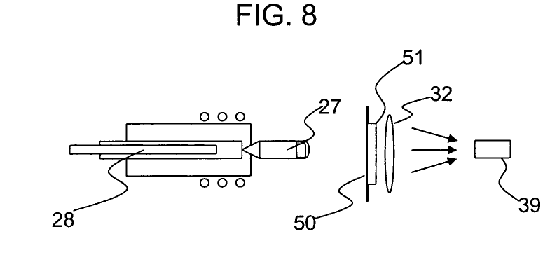

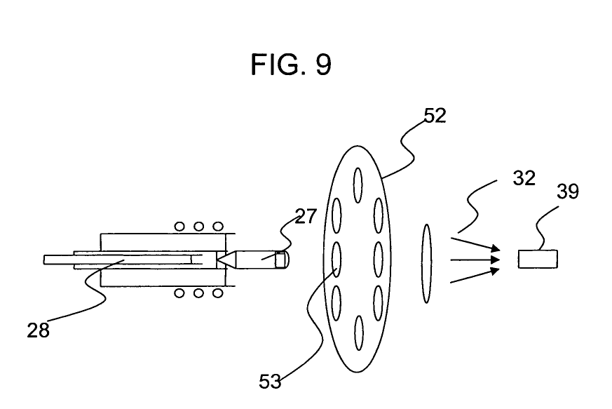

FIGS. 7, 8, and 9 show alternative mechanical optics protection schemes. Collection optics 32 must be physically isolated from the plasma 27 since the plasma generates ions which can cloud and obscure the optics. This would keep the spectrometer 34, which is detailed in FIG. 5, from receiving sufficient photons. Protection schemes include: moving tape 48, with take up reels 49 shown in FIG. 7; liquid or vapor barrier 50 that continuously flows over a window 51 as shown in FIG. 8; and an indexing wheel 52 with multiple disposable windows 53 as shown in FIG. 9.

Although the present invention has been described in terms of specific preferred embodiments, persons skilled in the art will recognize that many changes or modifications could be made in the course of practicing the present invention. For example the specifically described features could be combined in various ways. The sample water could be heated and ionized directly with microwave energy to both vaporize the water and then dissociate and ionize the gas. A continuous flow can be envisioned. A potential application is a laboratory version with closed loop water recycling system to provide the water. Another is a portable system that runs off of a refillable pure water supply. Multiple spectrometers optimized for specific wavelength bands could be used. A mass spectrometer (multiple types may be used) and scavenges the ions from the plasma instead of the optical emissions spectrometer could be added. The preferred embodiments show horizontal plasma orientation, but other orientation may be utilized. Collectors other that the elliptical collector could be used. Moving mirrors or actuated apertures to switch from radial to axial viewing are possibilities. The system may be operated at various pressures from above atmospheric to below atmospheric. The system may be combined with electrochemistry to concentrate and or measure contaminants. A solid vaporizer for monitoring of food supplies could be used. The 2b input stage may be implemented with the concentrating vessel operated at varying temperatures to allow sampling of vaporizing products with different vaporization temperatures. Operation with an open chamber that is not sealed is a possibility. The chamber could be made of materials other than fused silica or UV quartz.

Alternative embodiments might utilize different types of spectrometers. These might include novel spectroscopic techniques such as the phase encoded aperture that is utilized in high entendue spectrometry. High entendue spectrometry is well suited to a large plasma ball emitting into 4 pi sr. In addition other spectrometer types can be constructed with filters, prisms and etalons, any one of which might be optimized for a particular application.

Results generated with the present invention can be compared to fixed standards of allowed contamination and that when limits are exceeded, alarms can be activated. These alarms might include visible and audible alarms, and or remote communication via wired or wireless networks to a central or distributed control centers. In addition to fixed limits the results could also be processed in statistical process control software, which would allow monitoring of process coefficients such as Cp. and CpK and the generation of alarms based on changes in these coefficients.

The present invention can be applied in many situations such as: on line monitoring of elemental contaminates in water, laboratory monitoring of elemental contaminates in water, portable monitoring of water contamination, all of the above for molecular contaminants by looking either at the molecular spectral emissions or looking at the spectral emissions of the molecular dissociation products in the plasma. Concepts of the present invention could also be applied with a hydrocarbon solvent instead of water permitting monitoring of contaminants in fuel or food oils.

The ability to monitor drinking water supplies on a continuous basis is one of the benefits of this technology. Monitoring can be used on both the raw feed water and the processed water prior to distribution. The potential low cost of this technology even makes it possible to envision monitoring of water quality through out the distribution system. For water suppliers the ability to continuously monitor the quality of feed water, allows them to use water sources of less stable quality, creating new potential sources. The ability to monitor pre and post filtering enables them to operate the filtering in the most efficient manner. This is especially important with membrane systems such as reverse osmosis where accurate measurements of membrane loading can be used to reduce operating costs. For water emitters, this technology provides a cost effective method of assuring compliance with emission standards. Food and beverage producers and bottlers in areas with questionable water supply quality such as in developing countries can use this technology to assure quality and safety of their finished products. Those with stable supplies of high quality can reduce their operating cost by reducing the regulatory sampling costs. Any water user or emitter who has a high cost associated with contamination either financial, liability or regulatory can benefit from this equipment.

The present invention has many obvious advantages over similar prior art monitoring systems. These include: cost (very low operating cost and production cost); efficiency (microwave coupling into water vapor is greater than 95% efficient); no waste by products generated (everything out was in the input stream); allows continuous on line monitoring; as compared to air as a plasma source air introduces its own contaminants separate from the water; as compared to argon, a potentially greater sensitivity as there are no optical emissions other than the water (hydrogen and oxygen) and the contaminants so argon plasma lines do not have to be ignored in the data. Therefore, for all of the above reasons, the reader should determine the scope of the present invention by the appended claims and not by the particular examples that have been given.

What is claimed is:

1. A system for analysis of minute quantities of contaminants in a stream of liquid water containing contaminants comprising:
A. A vaporizer for vaporizing liquid water from said water stream of liquid water to produce water vapor;
B. a microwave or radio frequency driven plasma generator for generating a plasma from the water vapor and spectral emissions from some or all of said contaminants;
C. a spectrometer system for analyzing spectral emissions produced by the contaminants to provide an analysis of said contaminant; and
D. computer system providing control of said vaporizer, said plasma generator and said spectrometer.

2. The system as in claim 1 wherein said plasma generator is a microwave driven generator.

3. The system as in claim 1 wherein said plasma generator is a radio frequency driven generator.

4. The system as in claim 2 wherein said microwave driven generator is adapted to operate at frequencies in the range of about 2.45 GHz.

5. The system as in claim 3 wherein said radio frequency generator is adapted to operate at about 27.12 MHz.

6. The system as in claim 3 wherein said radio frequency generator is adapted to operate at about 40.68 MHz.

7. The system as in claim 1 wherein said spectrometer system comprises an entrance aperture, a grating and a sensor array.

8. The system as in claim 1 wherein said system further comprises a hot finger adapted to produce pure water vapor.

9. The system as in claim 1 wherein said spectrometer system comprises an elliptical collector defining two foci with plasma gas at the first foci and providing a virtual image at the second foci.

10. A method for analysis of minute quantities of contaminants in a stream of liquid water containing contaminants comprising the steps of:
A. utilizing a vaporizer to vaporize liquid water from said water stream of liquid water to produce water vapor;
B. generating a plasma from the water vapor and spectral emissions from some or all of said contaminants utilizing a plasma generator driven by microwave or radio frequency radiation;
C. analyzing spectral emissions produced by the contaminants to provide an analysis of said contaminant utilizing a spectrometer system; and
D. providing control of said vaporizer, said plasma generator and said spectrometer with a computer system.

11. The method as in claim 10 wherein said plasma generator is a microwave driven generator.

12. The method as in claim 10 wherein said plasma generator is a radio frequency driven generator.

13. The method as in claim 11 wherein said microwave driven generator is adapted to operate at frequencies in the range of about 2.45 GHz.

14. The method as in claim 12 wherein said radio frequency generator is adapted to operate at about 27.12 MHz.

15. The method as in claim 12 wherein said radio frequency generator is adapted to operate at about 40.68 MHz.

16. The method as in claim 10 wherein said spectrometer system comprises an entrance aperture, a grating and a sensor array.

17. The method as in claim 10 wherein a pure water source is used as a reference for self-calibration.

18. The method as in claim 10 wherein said computer system is adapted to provide variable power in the excitation process to selectively dissociate molecular contaminants.

19. The method as in claim 10 wherein protection of optical components in said spectrometer system is provided a with water curtain.

20. The method as in claim 10 wherein protection of optical components in said spectrometer system is provided a with a movable tape carrier.

21. The method as in claim 10 wherein protection of optical components in said spectrometer system is provided a with rotary wheel windows.
